(19) United States
(12) Patent Application Publication
(10) Pub. No.: US 2026/0181408 A1
(43) Pub. Date: Jun. 25, 2026

(54) METHODS, ARCHITECTURES, APPARATUSES, AND SYSTEMS FOR EXPLICIT INDICATION OF BASE STATION-BASED SENSING

(71) Applicant: InterDigital Patent Holdings, Inc., Wilmington, DE (US)

(72) Inventors: Fumihiro Hasegawa, Westmount (CA); Moon IL Lee, Melville, NY (US); Arman Shojaeifard, London (GB); Jongwoo Hong, New York, NY (US); Remun Koirala, London (GB); Paul Marinier, Brossard (CA); Ghyslain Pelletier, Montreal (CA)

(21) Appl. No.: 18/991,131

(22) Filed: Dec. 20, 2024

(51) Int. Cl. H04W 16/28; H04B 17/318; H04W 8/22; H04W 24/10

(52) U.S. Cl. CPC H04W 16/28; H04B 17/328; H04W 8/22; H04W 24/10

(57) ABSTRACT

Procedures, methods, architectures, apparatuses, systems, devices, and computer program products are provided for a wireless transmit/receive unit (WTRU) to communicate with a wireless network using base station-based sensing. A method includes receiving configuration information and spatial translation data from the network, determining transmission gain, and transmitting signals based on this gain. The spatial translation data includes details like antenna tilt and power offsets. The WTRU can adjust its operations based on the received signal strength and perform periodic measurements as requested by the network. The method also includes steps for managing resources and adjusting operations when base station-based sensing is deactivated.

### TECHNICAL FIELD

The present disclosure is generally directed to the fields of communications, hardware, software and encoding, including, for example, to methods, architectures, apparatuses, and systems related to sensing in wireless networks, including explicit indication of base station-based sensing.

### BACKGROUND

Functional specifications are provided for User Equipment (UE) positioning in the Next Generation Radio Access Network (NG-RAN). The specifications include descriptions of various positioning methods, including network-assisted Global Navigation Satellite System (GNSS), Observed Time Difference of Arrival (OTDOA), Enhanced Cell ID (E-CID), a barometric pressure sensor, Wireless Local Area Network (WLAN), Bluetooth, Terrestrial Beacon Systems (TBS), a motion sensor, New Radio (NR) Enhanced Cell Identifier (ID), Multi-Round Trip Time (RTT), Downlink Angle-of-Departure (DL-AoD), Downlink Time Difference of Arrival (DL-TDOA), Uplink Time Difference of Arrival (UL-TDOA), Uplink Angle-of-Arrival (UL-AoA), and sidelink (SL) positioning and ranging. The specifications include descriptions of an NG-RAN UE positioning architecture, including the roles and operations of elements like UE, Next Generation Node B (gNB), Next Generation Evolved Node B (ng-eNB), Location Management Function (LMF), and Positioning Reference Unit (PRU). Signaling protocols and interfaces used for positioning are described. The specifications include general positioning procedures, including Long-Term Evolution Positioning Protocol (LPP) and NR Positioning Protocol A (NRPPa), service layer support, and specific operations like On-Demand Positioning Reference Signal (PRS) configurations, preconfigured measurement gaps, and PRS processing windows. However, numerous technical challenges remain.

### SUMMARY

In certain representative embodiments, a method is performed by a wireless transmit/receive unit (WTRU) in communication with a wireless network. For example, the method includes at least one of: receiving, from the wireless network, configuration information indicating base station-based sensing capability and spatial translation information; receiving, from the wireless network, an indication indicating that the base station-based sensing is active;
determining a transmission gain based on the spatial translation information; or transmitting, to the wireless network, a signal based on the transmission gain.

In certain representative embodiments, a wireless transmit/receive unit (WTRU) is provided in communication with a wireless network. For example, the WTRU comprises a processor; and a transceiver coupled to the processor. Also, for example, the WTRU is configured to perform at least one of: receive, from the wireless network, configuration information indicating base station-based sensing capability and spatial translation information; receive, from the wireless network, an indication indicating that the base station-based sensing is active; determine a transmission gain based on the spatial translation information; or transmit, to the wireless network, a signal based on the transmission gain.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit and/or receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating examples of parameters for a measurement gap, in accordance with some embodiments of this disclosure;

FIG. 3A is a diagram illustrating an example of base station (e.g., gNB)-monostatic sensing, in accordance with some embodiments of this disclosure;

FIG. 3B is a diagram illustrating an example of bistatic sensing, in accordance with some embodiments of this disclosure;

FIG. 4 is a diagram illustrating an example of transmissions for communication and sensing measured by WTRUs, in accordance with some embodiments of this disclosure;

FIG. 5 is a diagram illustrating another example of transmissions for communication and sensing measured by a WTRU, in accordance with some embodiments of this disclosure;

FIG. 6 is a chart illustrating an example of scheduled time-frequency resources, in accordance with some embodiments of this disclosure;

FIG. 7 is a chart illustrating an example of a subset of scheduled resources used for gNB-sensing, in accordance with some embodiments of this disclosure;

FIG. 8 is a sequence diagram illustrating an example sequence of a procedure for signal exchange between a WTRU and a base station (e.g., gNB), in accordance with some embodiments of this disclosure; and

FIG. 9 is a procedural diagram illustrating an example procedure for a WTRU in communication with a wireless network performing base station-based sensing, in accordance with some embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc, and/or any portion thereof, it is to be understood that any embodiments described and/or claimed herein assume that any apparatus, system, device, etc, and/or any element thereof is configured to carry out any operation, process, algorithm, function, etc, and/or any portion thereof.

### Example Communications System

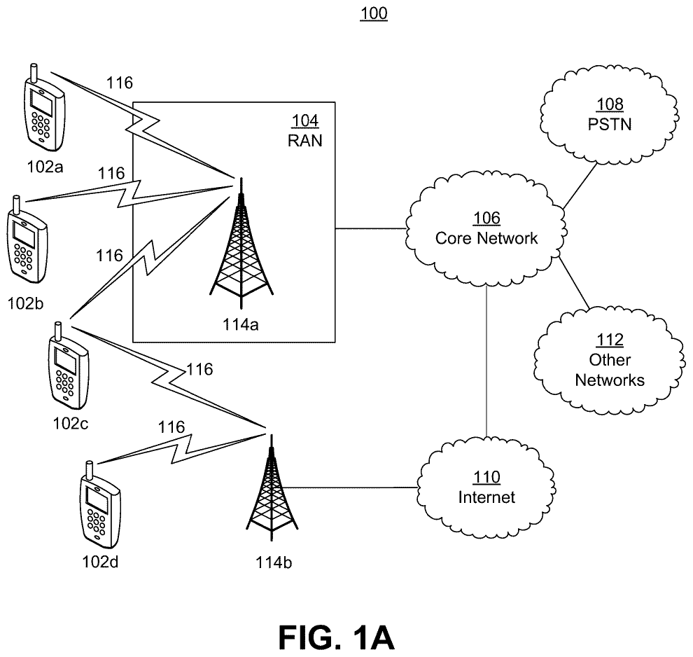

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit and/or receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable radio access technology (RAT) for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHZ, 80 MHZ, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHZ, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In certain representative embodiments, methods and systems are provided for explicit indication of base station (e.g., gNB)-based sensing. For example, the explicit indication of base station (e.g., gNB)-based sensing is provided, e.g., for Integrated Sensing and Communication (ISAC). Also, for example, measurement behavior is provided. Further, for example, measurement reporting is provided.

In certain representative embodiments, a WTRU is configured with configurations (e.g., power offset) to be applied when gNB-based sensing is active. For example, when a WTRU receives a gNB-based sensing activation notification from a network, the WTRU determines to apply a configuration. Also, for example, when a WTRU determines that the gNB sensing is deactivated, the WTRU determines to fallback to a configuration prior to gNB-based sensing.

In certain representative embodiments, either alone or in combination with one or more features of the methods and systems disclosed herein, a gNB may perform monostatic sensing or bistatic sensing. The gNB may not have time to inform the WTRUs about details of gNB-based sensing operation (e.g., intruder detection). Each time the gNB adjusts its transmission parameters, signal exchange needs happen between WTRU and gNB, causing latency in sensing operations. The gNB may perform both sensing and communication operation. Thus, the WTRU may need to perform communication related tasks (e.g., measuring Synchronization Signal Blocks (SSBs) and DL-RS, or the like) while gNB sensing is taking place.

In certain representative embodiments, either alone or in combination with one or more features of the methods and systems disclosed herein, a WTRU may send a request to the network for configuration (e.g., DL-RS configurations, UL-RS configurations, or the like), e.g., in at least one of Physical Uplink Shared Channel (PUSCH), Physical Uplink Control Channel (PUCCH), Uplink Control Information (UCI), Medium Access Control-Control Element (MAC-CE), Radio Resource Control (RRC), LTE Positioning Protocol (LPP) message, combinations of the same, or the like. For example, the request from the WTRU may include configurations of a measurement gap, a DL-RS processing window, a window for transmission of UL-RS, or the like.

The WTRU may send an acknowledgement message in PUSCH or PUCCH for a grant received from the network.

Two or more conditions and/or criteria can be used in a combination. The WTRU may be configured with two or more conditions and associated WTRU behavior. The WTRU may determine which behavior the WTRU shall use based on the applicable condition.

The WTRU can measure a DL-RS inside or outside of an active bandwidth part (BWP). The WTRU may transmit a UL-RS inside or outside of an active BWP.

The WTRU may be preconfigured with parameters (e.g., measurement gaps, DL-RS processing windows, DL-RS configurations, UL-RS configurations, or the like) via a semi-static message (e.g., LPP, RRC, or the like).

Any actions the WTRU determines to take may be configured by the network. For example, the WTRU may be configured with a rule and according to the rule, the WTRU may determine to take an associated action.

In addition to the measurements made on DL-RS, the WTRU may include at least one of the following cell-related measurements: SSB Reference Signal Received Power (RSRP) from the serving cell with corresponding cell ID, SSB RSRP from the one or more neighboring cells with one or more corresponding cell IDs, RSRP of Channel State Information Reference Signal (CSI-RS) with CSI-RS resource ID, RSRP of Demodulation Reference Signal (DM-RS), combinations of the same, or the like.

Throughout the present disclosure, the following terminology may be used. The following definitions generally apply unless noted otherwise or implied otherwise by context.

In this disclosure, “Network” may include AMF, LMF, gNB, NG-RAN, or the like.

“Pre-configuration” and “configuration” may be used interchangeably in this disclosure.

“Non-serving gNB” and “neighboring gNB” may be used interchangeably in this disclosure.

The terms “gNB” and Transmission Reception Point (“TRP”) may be used interchangeably in this disclosure.

“DL-RS” or “DL-RS resource” may be used interchangeably in this disclosure.

“DL-RS(s)” or “DL-RS resource(s)” may be used interchangeably in this disclosure. The aforementioned “DL-RS(s)” or “DL-RS resource(s)” may belong to different DL-RS resource sets.

“Measurement gap” or “measurement gap pattern” may be used interchangeably in this disclosure. “Measurement gap pattern” may include parameters such as measurement gap duration or measurement gap repetition period or measurement gap periodicity.

An LMF is a non-limiting example of a node or entity (e.g., network node or entity, or the like) that may be used for or to support positioning or sensing. Any other node or entity may be substituted for LMF and still be consistent with this disclosure.

The WTRU may receive one or more preconfigured thresholds from the network (e.g., LMF, gNB, or the like).

A Line of Sight (LoS) indicator may be a hard indicator (e.g., 1 or 0) or a soft indicator (e.g., 0, 0.1, 0.2, . . . , 1). The LoS indicator may indicate a likelihood of the presence of an LoS path between a TRP and a WTRU or along DL-RS. The LoS indicator can be associated with a TRP or PRS resource ID (e.g., index). The WTRU may receive the LoS indicator from the network per TRP or resource ID. Alternatively, the WTRU may determine the LoS indicator per TRP or resource ID based on measurements.

In the examples described herein, “ID” and “index” may be used interchangeably.

A WTRU location may be expressed in terms of altitude, latitude, geographic coordinate, local coordinate, or the like, for example.

In the examples described herein, a timestamp may be indicated by absolute time, relative time (e.g., in seconds) compared to a reference time, System Frame Number (SFN), slot index, frame index, subframe index and/or symbol index, or the like. Examples of “absolute time” may be Coordinate Universal Time (UTC) time, Global Navigation Satellite System (GNSS) time, locally defined absolute time (e.g., LTE Time, NR Time, or the like), or the like.

In the examples described herein, the WTRU may receive configurations for a time window such as duration (e.g., expressed in terms of seconds, number of symbols, number of slots, number of frames, number of subframes, or the like), start and/or end time (e.g., expressed in terms of absolute time, system time, relative time with respect to a reference time indicated by the network or determined by the WTRU, SNF index, slot index, symbol index, frame index, subframe index, or the like), or the like. The WTRU may receive two or more configurations of a time window where each configuration is associated with an index. The time window can be initiated with a trigger sent by the network. For example, the WTRU may receive a command (e.g., Downlink Control Information (DCI)) to initiate an indicated time window, indicated via the configuration index. The WTRU may determine to initiate the time window after a configured duration after reception of the command (e.g., N symbols, N slots, N frames, N seconds, or the like). The WTRU may receive an activation or deactivation command (e.g., DCI, MAC-CE, or the like) to activate or deactivate the time window, respectively, from the network.

In certain representative embodiments, either alone or in combination with one or more features of the methods and systems disclosed herein, one or more configurations for one or more RSs are provided. For example, the one or more configurations for the one or more RSs include at least one of one or more configurations for DL-RS, one or more configurations for UL-RS, a measurement gap, a prioritization window, one or more positioning techniques, one or more channel impulse responses (CIRs), one or more associations to one or more RS configurations, combinations of the same, or the like.

In one example, the WTRU may receive DL-RS and/or UL-RS (e.g., Sounding Reference Signal (SRS)) configurations for positioning purpose from the network (e.g., LMF). The LMF may forward the PRS configuration and SRS configurations to the gNB so that the gNB can schedule PRS transmission or SRS reception at the TRP, Transmission Point (TP) and/or Reception Point (RP).

For example, configurations for DL-RS are provided. In one example, a DL-RS configuration may contain at least one of the following parameters: number of symbols, transmission power, number of DL-RS resources included in DL-RS resource set, muting pattern for DL-RS (for example, the muting pattern may be expressed via a bitmap, or the like), periodicity, type of DL-RS (e.g., periodic, semi-persistent, or aperiodic, or the like), slot offset for periodic transmission for DL-RS, vertical shift of DL-RS pattern in the frequency domain, time gap during repetition, repetition factor, resource element (RE) offset, comb pattern, comb size, spatial relation (e.g., with respect to other DL-RSs or UL-RS such as SRS for positioning purpose, or the like), Quasi Co-Location (QCL) information (e.g., QCL target, QCL source, or the like) for DL-RS, number of TRPs, Absolute Radio-Frequency Channel Number (ARFCN), subcarrier spacing, expected Reference Signal Time Difference (RSTD), uncertainty in expected RSTD, start Physical Resource Block (PRB), bandwidth, BWP ID, number of frequency layers, start and/or end time for DL-RS transmission, on and/or off indicator for DL-RS, TRP ID, DL-RS ID, cell ID, global cell ID and applicable time window, or the like. The WTRU may apply a DL-RS configuration under a condition that the current time is within the applicable time window. “ID” may be used interchangeably with “index”. Examples of DL-RS include CSI-RS, Phase Tracking Reference Signal (PTRS), PRS, TRS, SSB, or the like.

For example, configurations for UL-RS are provided. In one example, UL-RS or SRS configuration may include at least one of: resource ID; comb offset values, cyclic shift values; start position in the frequency domain; number of UL-RS symbols; shift in the frequency domain for UL-RS; frequency hopping pattern; type of UL-RS (e.g., aperiodic, semi-persistent, periodic, or the like); sequence ID used to generate UL-RS, or other IDs used to generate UL-RS sequence; spatial relation information, indicating which reference signal (e.g., DL-RS, UL-RS, CSI-RS, SRS, DM-RS, or the like) or SSB (e.g., SSB ID, cell ID of the SSB, or the like) the UL-RS is related to spatially where the UL-RS and DL-RS may be aligned spatially; QCL information (e.g., a QCL relationship between UL-RS and other reference signals or SSB, or the like); QCL type (e.g., QCL type A, QCL type B, QCL type C, QCL type D, or the like); resource set ID; list of UL-RS resources in the resource set; transmission power related information; pathloss reference information which may contain index for SSB, CSI-RS or DL-RS; periodicity of UL-RS transmission; bandwidth (e.g., in terms of resource blocks, MHz, or the like); carrier frequency; center frequency; and/or spatial information such as spatial direction information of UL-RS transmission (e.g., beam information, angles of transmission, or the like), spatial direction information of DL-RS reception (e.g., beam ID used to receive DL-RS, angle of arrival, or the like); combinations of the same; or the like. Again, it is noted, “ID” may be used interchangeably with “index”. Examples of UL-RS include SRS, and SRS for positioning purpose, or the like.

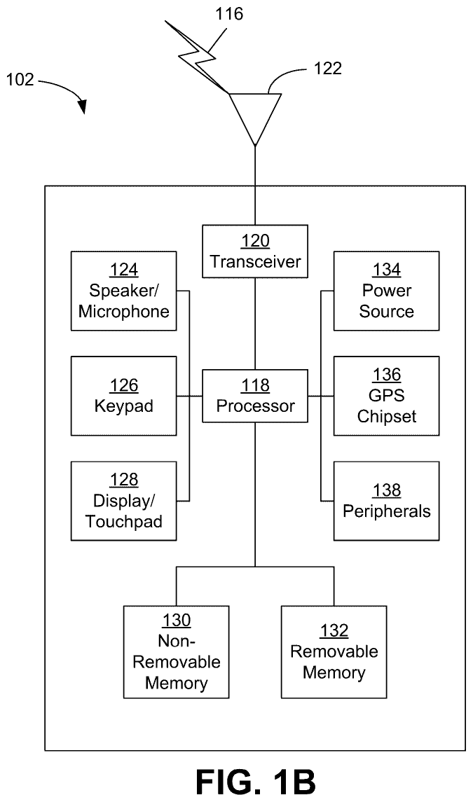

For example, a measurement gap or prioritization window is provided. Also, for example, the WTRU is configured to receive DL-RS during a DL-RS processing window or measurement gap. The measurement gap or DL-RS processing window may be configured by the network (e.g., LMF, gNB, or the like). Examples of the parameters of a measurement gap or DL-RS processing window are shown in FIG. 2. Similar parameters may be defined for a DL-RS processing window. During the measurement gap, indicated by “measurement gap length” in FIG. 2, the WTRU may receive an indication and/or configuration to make measurements on DL-RS during the gap length and process the measurements. Each measurement gap pattern or DL-RS processing window pattern may be characterized by a set of gap length, gap periodicity, and/or offset, or the like. A priority level may be associated with a DL-RS prioritization window. The WTRU may receive a message from the network (e.g., gNB, LMF, or the like) indicating the priority level of the PRS prioritization window.

For example, either alone or in combination with one or more features of the methods and systems disclosed herein, positioning techniques are provided. In 3GPP, the following categories of WTRU positioning techniques are specified. A “DL positioning method” may refer to any positioning method that uses downlink reference signals such as PRS. The WTRU receives multiple reference signals from TPs and measures DL-RSTD and/or RSRP. Examples of DL positioning methods are DL-AoD or DL-TDOA positioning. A “UL positioning method” may refer to any positioning method that uses uplink reference signals such as SRS for positioning. The WTRU transmits SRS to multiple RPs and the RPs measure the UL Relative Time of Arrival (RToA) and/or RSRP. Examples of UL positioning methods are UL-TDOA or UL-AoA positioning. A “DL and UL positioning method” may refer to any positioning method that uses both uplink and downlink reference signals for positioning. In one example, a WTRU transmits SRS to multiple TRPs and gNB measures reception-transmission time difference, which is calculated based on the time of arrival of DL-RS (e.g., PRS). The gNB can measure RSRP for the received SRS. The WTRU measures reception-transmission time difference for PRS transmitted from multiple TRPs. The WTRU can measure RSRP for the received PRS. The reception-transmission difference and possibly RSRP measured at WTRU and gNB are used to compute round trip time. Here “WTRU reception-transmission time difference” refers to the difference between arrival time of the reference signal transmitted by the TRP and transmission time of the reference signal transmitted from the WTRU. An example of DL and UL positioning method is multi-RTT positioning.

For example, details related to CIR and its association to RS configurations are provided. An example of measurement may be a CIR. A CIR, consisting of N paths, may be defined by the following equation

$$h ( t ) = {\sum }_{k = 1}^{N} {h}_{k} ( t ) δ ( t - {τ}_{k} )$$

where hₖ(t) and τₖ are time-varying complex valued coefficients (e.g., expressed by a+bj where j=\sqrt{−1} for the CIR and delay, measured in seconds, for the kth path, respectively). The delta function is defined as δ(t)=1 for t=0 and δ(t)=0 for t≠0.

For example, it is assumed the coefficients are constant over time, e.g., hₖ(t)=hₖ. The WTRU may report hₖ and τₖ for each path k to the network. The WTRU may report the number of paths, N, to the network. Alternatively, the WTRU may receive hₖ and τₖ for each path k from the network and/or the number of paths.

In another example, the WTRU may obtain CIR from the network. The network may indicate one or more DL-RS configurations such as DL-RS resource IDs associated with the CIR. For example, the CIR may be associated with DL-RS resource ID. In this case, the WTRU may determine that the CIR is derived based on the measurements made on the DL-RS resource associated with the ID. Alternatively, the WTRU may determine that the channel along the direction of transmission of the DL-RS or reception of the DL-RS corresponds to the CIR.

In another example, the CIR may be associated with a TRP ID. In this case, the WTRU may determine that the CIR represents the channel between the associated TRP and WTRU. In another example, the CIR may be associated with two or more TRPs where the network may include TRP indices associated with the CIR.

In another example, the CIR may be associated with a cell. In this case, the WTRU may receive cell ID or index associated with the CIR from the network.

In another example, CIR may be associated with two or more TRPs or DL-RS resource IDs. In this case, the WTRU may determine that the channel between the TRPs and the WTRU corresponds to the CIR. Alternatively, the WTRU may determine that the channel along the transmission directions of DL-RSs associated with IDs or reception directions of the DL-RS correspond to the CIR.

In another example, two or more CIRs may be associated with one parameter from DL-RS configurations (e.g., TRP ID, DL-RS resource ID, frequency layer ID, or the like). For example, the WTRU may receive information related to two CIRs associated with a TRP from the network, e.g.,

$${h}_{1} ( t ) = {\sum }_{k = 1}^{{N}_{1}} {h}_{1 , k} ( t ) δ ( t - {τ}_{1 , k} ) and {h}_{2} ( t ) = {\sum }_{k = 1}^{{N}_{2}} {h}_{2 , k} ( t ) δ ( t - {τ}_{2 , k} )$$

from the network. Alternatively, the WTRU may report information related to two or more CIRs associated with DL-RS configuration (e.g., TRP ID, DL-RS resource ID, or the like) based on the measurements to the network. There can be two or more CIRs associated with DL-RS configuration since the WTRU or network may observe different channel characteristics based on AoA of DL-RS or UL-RS, for example.

For example, CIR may be represented by delay profile (DP) or power delay profile (PDP). A power delay profile may be defined as a set of delays and power profiles, such as [τ₀, τ₁, . . . , τ_{N-1}] and [p₀, p₁, . . . , p_{N-1}], where P& may correspond to relative power at the kth path compared to the first path. A delay profile may be defined as a set of delays [τ₀, τ₁, . . . , τ_{N-1}] which indicates path delay for each path above p_{threshold}. The WTRU may receive p_{threshold} from the network to derive delay profile from power delay profile.

In another example, the CIR the WTRU reports to the network may be defined by a configured number of samples (e.g., N) where the WTRU is configured with a granularity of samples (e.g., X seconds apart). The number of samples may be defined within a window. The WTRU may report samples whose RSRP is over the configured threshold or an M highest RSRP among the samples. The WTRU may indicate locations or a sample index of samples where the WTRU measures an M highest RSRP among the samples. The first sample may be defined as the earliest arriving path, e.g., first path. In another example, the samples may be defined with respect to the reference timing (e.g., ToA of reference or indicated DL-RS, ToA of the earliest arriving DL-RS, or the like). The WTRU may report timing, phase and/or power information per sample. The determined reference timing or first path may be rounded up or down to the defined timing granularity. The CIR, PDP and/or DP may be defined as the impulse response between WTRU and TRP or associated with a DL-RS (e.g., DL-RS resource ID) or DL-RS resources (e.g., DL-RS resource IDs).

In one example, the WTRU may receive an indication from the network on how to generate CIR, PDP and/or DP based on timing, phase and/or power measurements. In one example, the WTRU may send a request to the network to receive an indication on which methodologies to use to generate CIR, PDP and/or DP based on the measurements the WTRU made. For example, the WTRU may receive a message from the network (e.g., via LPP, RRC, MAC-CE, DCI, or the like) indicating the DL-RS resource indices and one or more associated measurement types (e.g., RSTD, AOA, or the like) to use to generate CIR, PDP and/or DP. In one example, the WTRU may receive an indication from the network indicating to generate CIR, PDP and/or DP.

In one example, the WTRU may receive a threshold (e.g., power threshold) from the network and timing range (e.g., 0 μs to 1 μs), timing granularity (e.g., every 0.1 us in the indicated timing range, 100 sample points in the indicated timing range, or the like) of CIR, PDP and/or DP. In this case, the WTRU may determine to report power and timing (e.g., relative timing compared to a reference timing, absolute timing, or the like) of any samples whose received power is over the threshold.

The WTRU may send measurements in a report to the network (e.g., LMF, gNB, or the like) via a semi-static (e.g., LPP, RRC, or the like) or dynamic message (e.g., UCI, UL MAC-CE, or the like).

In the examples herein, DL-RS (e.g., CSI-RS, DM-RS, TRS, or the like) and SSB may be used interchangeably.

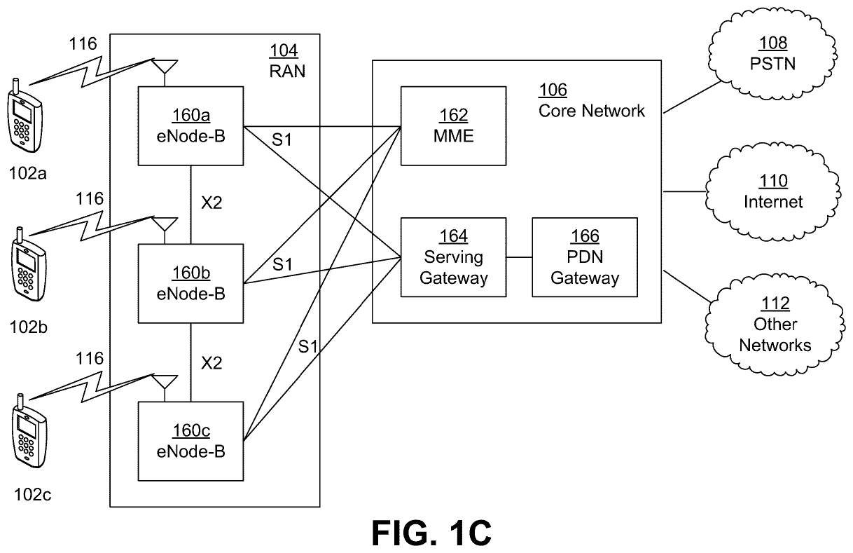

In certain representative embodiments, a wireless network (e.g., LMF, gNB, or the like) performs gNB-based monostatic sensing or bistatic sensing. Examples of monostatic sensing and bistatic sensing are shown in FIGS. 3A and 3B, respectively, where one or more TRPs are attempting to detect a target (e.g., automobile). FIGS. 3A and 3B are detailed below.

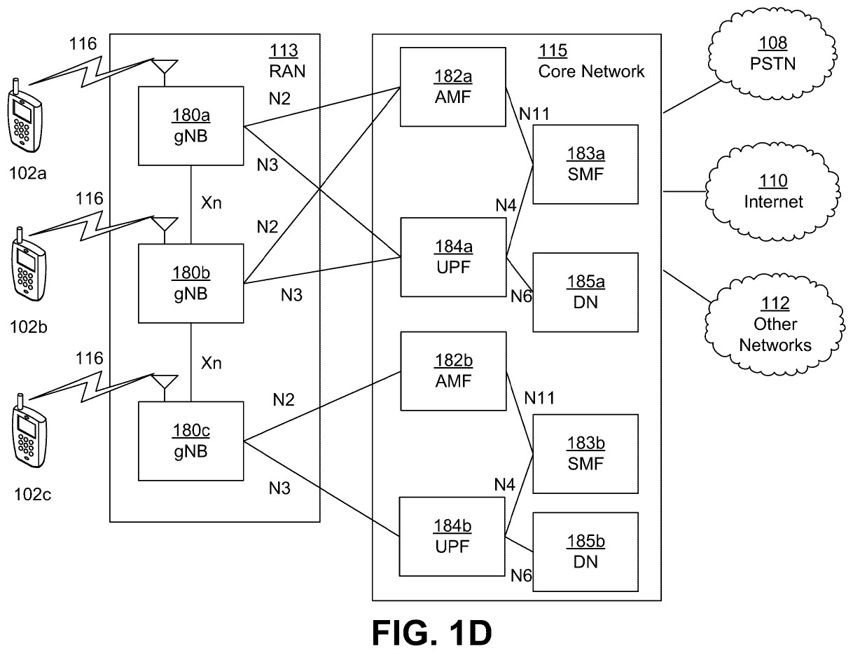

In certain representative embodiments, a gNB may perform sensing and may switch an antenna for a sensing or communication purpose as shown in FIG. 4, detailed below. For example, a system is provided to reduce overhead in signaling during gNB-based sensing. Also, for example, a WTRU is configured to determine gNB-based sensing and to reduce falsely triggered actions (e.g., pathloss update, spatial adjustment, or the like).

In certain representative embodiments, a WTRU performs one or more actions and/or steps. For example, the WTRU is configured to perform at least one of receiving a configuration, receiving a notification of gNB sensing, determining that gNB sensing is deactivated, determining use of a remaining resource for communication, combinations of the same, or the like.

For example, the WTRU receives configurations related to gNB sensing (e.g., a change in antenna tilt, a duration of applied tilt, an association between tilt and power offset, a translation in spatial information, or the like). Also, for example, a configuration includes an index associated with a power offset and spatial information translation. Further, for example, the WTRU receives, from the network, a notification that gNB sensing is activated or active. In addition, for example, the WTRU determines a power offset, e.g., if tilt is applied at the gNB, the WTRU determines to add an associated power offset to a measured RSRP. Moreover, for example, the WTRU determines to use a subset of resources (e.g., sensing uses part of configured resources). Furthermore, for example, the WTRU determines to not transmit or receive in certain time-frequency resources. It is noted, throughout the present specification, where “time-frequency” is used, it is understood to mean time and/or frequency. Additionally, for example, the WTRU determines if a received RSRP is above a configured threshold, a measurement window is increased for determination of RSRP (e.g., SSB, CSI-RS, or the like). Still further, for example, the WTRU determines if the received RSRP is not above the configured threshold, the WTRU does not make any measurement. Even further, for example, if requested, the WTRU makes periodic measurements on a received signal for sensing and report measurements (e.g., logging). Yet further, for example, the WTRU determines to change a reception spatial filter (e.g., to account for a tilted angle, e.g., of a base station or other transmitter) based on a translated spatial association (e.g., CSI-RS #1 during communication to CSI-RS #3 during gNB sensing). Further still, for example, the WTRU determines that gNB sensing is deactivated. The WTRU may determines that gNB sensing is deactivated based on one at least one of the following conditions: if the WTRU receives notification of deactivation of gNB sensing, if the WTRU does not receive RS for sensing for a configured duration, combinations of the same, or the like. Also, for example, if time remains for communication resources, the WTRU determines to use a remaining resource for communication.

In certain representative embodiments, gNB-based sensing includes at least one of an indication of a configuration to use, a configuration for sensing, an overriding configuration, network signaling for gNB-based sensing, WTRU-assisted gNB-based sensing, combinations of the same, or the like.

For example, one or more indications of one or more configurations to use for gNB-based sensing are provided. Also, for example, the one or more indications of the one or more configurations to use for gNB-based sensing include at least one of an update of spatial information, a power offset applied to one or more measurements, a power offset applied to transmission power, resource usage, a combination of a power offset and one or more spatial relationships, a time window, a measurement window, a request to deactivate or activate gNB-based sensing, a measurement gap, an overriding configuration, a cancellation behavior, a timer for gNB-sensing, an expected starting time, post-sensing WTRU action (e.g., action after gNB-based sensing is deactivated), combinations of the same, or the like.

For example, in gNB-based sensing, a gNB transmits a reference signal towards a target. Also, for example, in monostatic sensing, the gNB (e.g., TRP) which transmits the reference signal receives the reflected signal. Further, in bistatic gNB-based sensing, there are two gNBs (e.g., TRPs), namely a transmission or transmitter (Tx) TRP and a reception or receiver (Rx) TRP, which transmit and receive the reference signal, respectively.

Examples of monostatic and bistatic gNB sensing are shown in FIGS. 3A and 3B. For example, as shown in FIG. 3A, a system 300 includes a TRP 305, which transmits a DL-RS 310, which may be received (and may be measured) by a WTRU 320. Also, for example, a target 315 is sensed by the TRP 305 via monostatic sensing. Further, for example, as shown in FIG. 3B, a system 350 includes a transmitting (Tx) TRP 355, which transmits a DL-RS 360, which may be received (and may be measured) by a WTRU 370. In addition, for example, a target 365 is sensed by the Tx TRP 355 and a receiving (Rx) TRP 380 via bistatic sensing.

For example, during gNB-based sensing, the gNB may change antenna settings for a sensing purpose. The gNB may change the transmission configuration (e.g., direction of Tx beam or antenna tilt, configuration of a Tx antenna or Rx antenna, AoD of DL-RS) during gNB-based sensing. Also, for example, as shown in FIG. 4, a system 400 includes a Tx gNB 410, which transmits a Tx beam for communication 415, which may be received (and may be measured) by a WTRU 430 and/or a WTRU 440, and/or a Tx beam for sensing 420, which may be received (and may be measured) by the WTRU 430 and/or the WTRU 440. Further, for example, a target 450 is sensed by the Tx TRP 410 and an Rx TRP 460 via bistatic sensing. In addition, for example, the Tx gNB 410 changes a direction of a Tx beam or an antenna tilt during gNB-based sensing. The Tx gNB 410 may change back to the Tx beam or antenna tilt used for communication once gNB-based sensing is over. The WTRU 430 and/or the WTRU 440 may not receive notification about the details of the change in the antenna settings from the network. The WTRU 430 and/or the WTRU 440 may need to update transmission and/or reception settings so that transmitted signals and/or channels are received by the network, e.g., by maximizing the received power. The WTRU 430 and/or the WTRU 440 may adjust reception settings so that one or more behaviors are triggered and/or prevented from being performed at the respective WTRU.

In one example, the gNB (e.g., 410) may perform both sensing and communication. In this case, the WTRU (e.g., 430) may determine a suitable configuration for transmission of UL signals or channels and reception of DL signals or channels (e.g., Physical Downlink Shared Channel (PDSCH), Physical Downlink Control Channel (PDCCH), or the like) during gNB-based sensing.

For example, an update of spatial information is provided. In one example, the WTRU may determine to update the direction of transmission of UL signals or channels according to a configured update rule. In one example, the WTRU may determine a transmission filter (e.g., a direction of transmission of UL signals or channels) based on a direction (e.g., AoA) the WTRU receives the DL-RS (e.g., CSI-RS with an index) indicated by the network (e.g., LMF, gNB, or the like). Also, for example, a DL-RS may be identified by its configuration detail (e.g., CSI-RS resource ID).

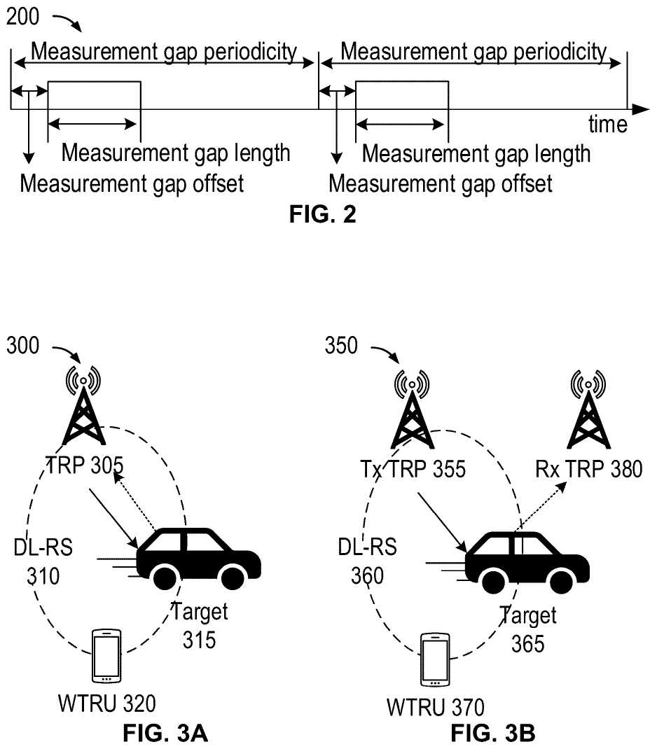

For example, as shown in FIG. 5, a system 500 includes a TRP 510, which transmits a Tx beam for communication (lower cone in FIG. 5), which is received (and may be measured) by a WTRU 530, and/or a Tx beam for sensing (upper cone in FIG. 5), which may be received (and may be measured) by the WTRU 530. Also, for example, the TRP 510 changes a Tx direction of DL-RS during sensing (e.g., TRP AoD 520 in FIG. 5) compared to a Tx direction used during communication (e.g., TRP AoD 515 in FIG. 5). Further, for example, the WTRU 530 adapts to the direction used by the TRP 510 since a reception direction of the TRP 510 may change accordingly. Thus, while gNB-based sensing is active, the WTRU 530 may determine to use WTRU AoD 540, as illustrated in FIG. 5, as a Tx direction of UL-RS or UL channels (e.g., PUCCH, PUSCH, or the like). In addition, for example, the WTRU 530 may determine to use WTRU AoD 535, as illustrated in FIG. 5, as a Tx direction of UL-RS or UL channels during communication.

For example, a change in AoD of transmission signals or AoA for reception may be referred to as a change in a spatial domain filter.

An example of translation in spatial information is described herein. For example, the WTRU may receive, from the network via a message (e.g., via LPP, RRC, MAC-CE, DCI, or the like), an association between two DL-RSs (e.g., CSI-RS #1 and CSI-RS #4, or the like). According to the example, the WTRU may be configured, prior to gNB-based sensing, to transmit SRS #1 in a direction of reception of CSI-RS #1. The WTRU may receive, from the network, an indicator to change a spatial relationship of SRS #1 via a dynamic (e.g., DCI, MAC-CE, or the like) or semi-static message (e.g., LPP, RRC, or the like). Based on the message, the WTRU may determine to update the spatial relationship for the SRS (e.g., SRS #1) according to the association (e.g., translation of spatial information). Using the example, if the WTRU receives the indication to change the spatial relationship, the WTRU may determine to update the transmission filter (e.g., spatial domain filter) of SRS #1 toward the direction of the reception of CSI-RS #4. If the WTRU receives the indication to change the spatial relationship again, the WTRU may determine to update the transmission filter of SRS #1 toward the direction of the reception of CSI-RS #1 (e.g., default spatial relationship). The WTRU may be configured with two or more spatial relationships so that, e.g., during gNB sensing, the WTRU can switch Tx direction to maximize reception power at the gNB.

In another example, the WTRU may receive an association with two or more DL-RSs (e.g., associating CSI-RS #1, CSI-RS #3, CSI-RS #5, or the like). The WTRU may receive, from the network, an index, indicating which DL-RS to use for determining the transmission filter (e.g., index #3 refers to CSI-RS #5 in the example).

In another example, the WTRU may receive two or more associations of DL-RSs. For example, the WTRU may receive two associations, namely CSI-RS #1 and CSI-RS #2, and CSI-RS #3 and CSI-RS #4. When the WTRU receives a message from the network to update spatial relationships and if the WTRU is configured with two SRS Tx directions toward CSI-RS #1 and CSI-RS #3, the WTRU may determine to update a Tx direction toward the direction the WTRU receives CSI-RS #2 and CSI-RS #4, respectively.

In another example, the WTRU may receive an indication as to which UL-RSs to apply the indicated change for the transmission filter. For example, the WTRU may receive from the network an indicator to apply the change to the transmission filter for SRS. In another example, the WTRU may receive from the network an indicator to apply the change to the transmission filter for a UL Demodulation Reference Signal (DMRS).

In another example, the WTRU may receive a message indicating to update the reception filter (e.g., Rx direction). In this example, the WTRU may receive an association between two DL-RSs. The WTRU may receive an indication as to which DL-RSs to spatially align with respect to a reception filter. The WTRU may be configured with the reception filter, which can receive an indicated DL-RS (e.g., CSI-RS #1).

In one example, the WTRU may receive an angle offset (e.g., in degrees, radians, or the like) from the network. The WTRU may receive a message from the network indicating to apply the configured angle offset to Tx direction of UL-RS or channels or reception direction of DL signals or channels. In another example, the WTRU may receive a message from the network indicating the UL-RS resource index to which the configured angle offset should be applied. The WTRU may receive a message indicating the DL-RS resource index implying that the WTRU should apply the configured angle offset to the reception spatial filter to receive the indicated DL-RS.

For example, a power offset is applied to one or more measurements. In one example, the WTRU may determine to add a determined power offset to a received RSRP. During gNB-based sensing, the WTRU may experience lower RSRP for the received signals (e.g., SSB) due to the change in the transmission settings (e.g., change in antenna tilt). Lowered RSRP of the received signal at the WTRU may trigger the WTRU to perform one or more configured actions (e.g., initial access, beam failure request, or the like). As gNB-based sensing may be temporary, it may be wasteful, in terms of resources used by the WTRU, to send a request for reconfiguration of parameters via initial access or beam failure request, for example. In the example presented herein, the WTRU intentionally adds a power offset to the received RSRP so that such actions are not triggered. Also, for example, the WTRU may be configured with a power offset or determine to apply the configured power offset when the WTRU receives a message from the network indicating the configured power offset, the gNB is performing gNB-based sensing, request to apply or add the power offset to power measurements or the like.

Based on the received message, the WTRU may determine to add the configured power offset to the power measurement (e.g., RSPR) for the received signal. In another example, the WTRU may receive two or more power offsets from the network where each power offset is associated with an index. The WTRU may receive a message from the network indicating the index corresponding to the power offset to use.

In one example, the WTRU may receive a message from the network, which includes IDs or indices of RSs or signals (e.g., SSB index, CSI-RS resource index, or the like), instructing the WTRU to apply the configured power offset to measurements for indicated DL-RS. For example, the WTRU may receive, from the network, an indication to apply the power offset to SSB RSRP where the WTRU may receive, from the network, the SSB index indicating which SSB measurement the WTRU should apply the offset. In another example, the WTRU may receive an indication to apply the power offset to DL-RS (e.g., CSI-RS) used for beam management, Radio Resource Management (RRM), or the like. In one example, the WTRU may receive, from the network, a power offset per DL-RS (e.g., per CSI-RS resource ID) or DL-RS type (e.g., DMRS, CSI-RS, TRS, PTRS, or the like). If the WTRU receives an indication or request to apply the power offset, the WTRU may determine to add the power offset to corresponding power measurements of the indicated DL-RS(s).

In one example, the WTRU may receive one or more configurations (e.g., power offset, association between DL-RSs, or the like) via unicast, multicast or groupcast.

For example, a power offset applied to transmission power is provided. In one example, the WTRU may be configured with a power offset that is to be applied to a transmission power of a UL-RS and/or channels while gNB-based sensing is active. Also, for example, the WTRU may receive configurations from the network indicating which SRS (e.g., via SRS resource ID) to apply the power offset. Once the WTRU determines that gNB-based sensing is active, the WTRU may determine to apply the power offset to indicated UL-RSs or channels (e.g., PUCCH, PUSCH, or the like). Once the WTRU determines that gNB-based sensing is deactivated, the WTRU may switch back to the transmission power level used prior to gNB-based sensing or a default transmission power level.

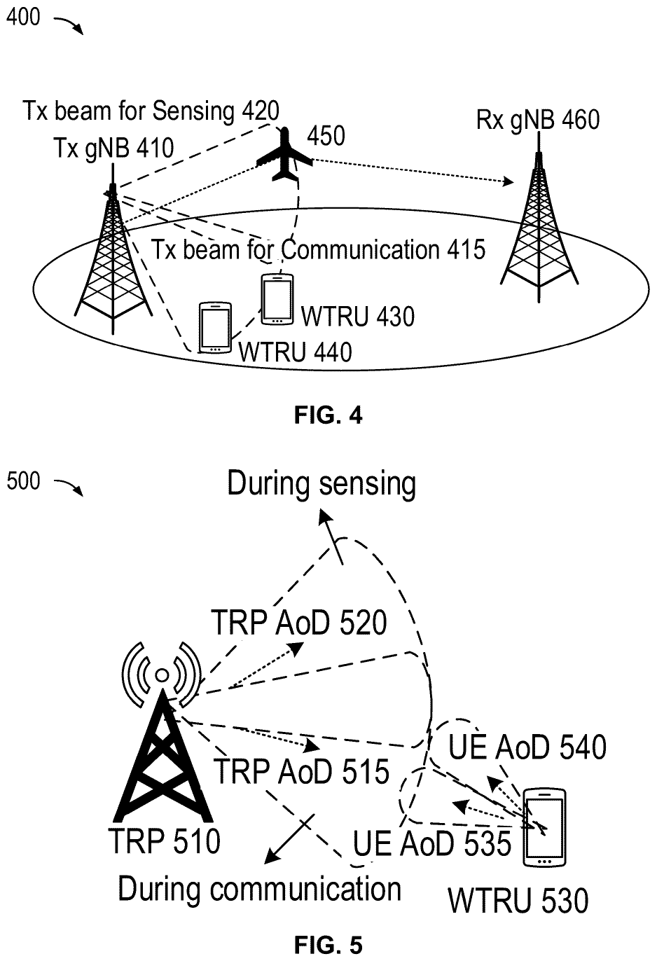

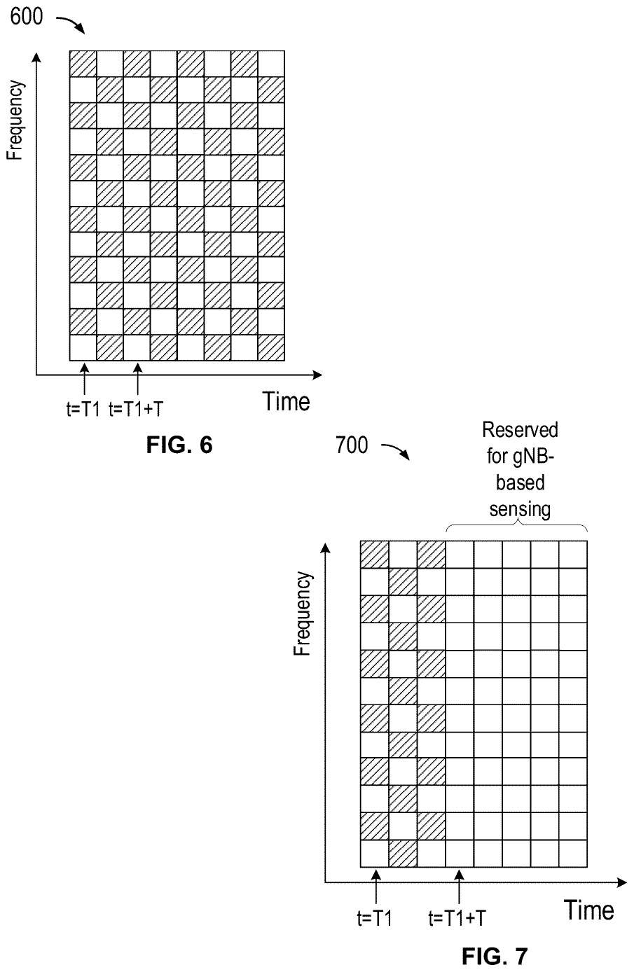

For example, resource usage is provided. In one example, the WTRU may determine to use a subset of scheduled or configured time-frequency resources while gNB-based sensing is active. Also, for example, the WTRU may be configured with N symbols and bandwidth of P MHz. The WTRU may receive an indication from the network that the gNB is performing the gNB-based sensing. The WTRU may be configured with resources allocated for gNB-based sensing. The WTRU may determine, based on the configuration, to use N1 symbols where N1<N and/or P1 MHz where P1<P where N1 symbols and P1 MHz are a subset of the scheduled N symbols and P MHz. An example is illustrated in FIG. 6. In FIG. 6, a chart 600 plots frequency on the y-axis versus time on the x-axis. In FIG. 6, a WTRU is scheduled with eight OFDM symbols with twelve resource elements for each OFDM symbol. Shaded boxes in FIG. 6 indicate where a DL-RS are located. The WTRU may be configured to make measurements on the received DL-RS. If the WTRU receives a message from the network, indicating that gNB-sensing is activated, the WTRU may determine that a subset of the scheduled resources is used for gNB-based sensing. Further, for example, the WTRU may be configured to reserve the last five symbols of the scheduled resources for gNB-based sensing. In FIG. 7, a chart 700 also plots frequency on the y-axis versus time on the x-axis. As illustrated in FIG. 7, the WTRU reserves the last five symbols (e.g., starting at t=T1+T) of the scheduled resources for gNB-based sensing. The WTRU determines to make measurements on the OFDM symbols between t=T1 and t=T1+T.

For example, a combination of a power offset and one or more spatial relationships is provided. In one example, the WTRU may be configured to perform the combination of the examples described herein. Also, for example, the WTRU may receive a combination of a spatial update (e.g., translation of DL-RSs, angle offset, or the like) and a power offset. The WTRU may receive two or more combinations where each combination is associated with an index. The WTRU may receive a message from the network indicating an index which corresponds to the spatial update (e.g., translation in spatial information) and the power offset the WTRU should apply to the UL-RS transmission or power measurements, respectively.

For example, a time window is provided. In one example, the WTRU may receive, from the network (e.g., LMF, gNB, or the like), configurations related to time windows. The WTRU may determine to apply the indicated change (e.g., power offset, update spatial information, or the like) during the configured or activated time window. The WTRU may receive configurations (e.g., start time, end time, duration, or the like) for two or more time windows where each configuration is associated with an index. The WTRU may receive an activation or deactivation command which contains the index, activating or deactivating the indicated time window, respectively. The time windows may be periodic and the WTRU may determine to apply the change in configurations periodically, following the periodicity of the window. In one example, the WTRU may determine that gNB-based sensing is active during the time window.

For example, a measurement window is provided. In one example, the WTRU may determine to make a measurement over a time window (e.g., measurement window) while gNB sensing is active. Also, for example, if the received RSRP of DL signals (e.g., SSB) or RSs is above a configured threshold, the WTRU may determine to make measurements over a time window. The WTRU may make measurements on periodically transmitted DL signals or RSs such that the WTRU can average the measurements (e.g., RSRP), for example. The WTRU may be configured with the threshold so that the if the WTRU receives signals with enough power, the WTRU may determine to improve reception of the signal by making measurements over a longer duration. The WTRU may receive configuration of the time window from the network.

In one example, if the measurement of the DL signal or RSs is below the threshold, the WTRU does not make any measurement on the received signal while the gNB-based sensing is active.

For example, a request to deactivate or activate gNB-based sensing is provided. In one example, the WTRU may determine to send a request (e.g., via an RRC, LPP, UCI, MAC-CE message, or the like) to deactivate gNB-based sensing. In the request, the WTRU may include at least one of the following information: desired time (e.g., relative, absolute time, or the like) to deactivate gNB-based sensing; session ID for gNB-based sensing if the WTRU receives a session ID for gNB-based sensing in physical, MAC, network or application layer; gNB sensing information (e.g., DL-RS resource ID used for gNB-sensing, DL-RS resource ID that collides with DL-RS resource ID used for gNB-based sensing, or the like); combinations of the same; or the like.

The WTRU may receive a response from the gNB, indicating that gNB-based sensing is deactivated.

In another example, the WTRU may send a request to the network to activate gNB-based sensing. The WTRU may include at least one of the following information: desired time (e.g., relative, absolute time, or the like) to deactivate gNB-based sensing; gNB sensing information (e.g., desired DL-RS resource ID used for gNB-sensing, desired DL-RS configuration (e.g., spatial direction, periodicity, start time, or the like); UL-RS configuration which can be used by the network to determine which direction or how often the sensing RS can be transmitted, or the like); combinations of the same; or the like.

For example, a measurement gap is provided. Also, for example, during the gNB-based sensing, the WTRU may determine that the network cannot receive signals or channels transmitted by the WTRU. In one example, the WTRU may be configured with one or more measurement gap configurations. Also, for example, each measurement gap configuration may consist of periodicity and duration. Based on the determined periodicity and duration of sensing RS, the WTRU may determine the measurement gap configuration where the WTRU may not transmit UL signals or channels or make measurements during the gap duration.

In another example, the WTRU may be configured with time windows with associated priority. Based on the determined periodicity and duration of sensing RS, the WTRU may determine the time window configuration (e.g., duration, periodicity, or the like). The WTRU may determine to receive DL signals or channels or transmit UL signals (e.g., UL-RS, a scheduling request, or the like) or channels according to the priority level associated with the window. For example, if gNB sensing signals are associated with a higher priority than the DL signals or UL signals the WTRU is scheduled to receive or transmit, respectively, the WTRU may determine to cancel reception or transmission of scheduled DL signals or UL signals during the window, respectively. In another example, if gNB sensing signals are associated with lower priority than the DL signals or UL signals the WTRU is scheduled to receive or transmit, respectively, the WTRU may determine to receive or transmit scheduled DL signals or UL signals during the window, respectively.

For example, one or more overriding configurations are provided. In one example, the WTRU may determine to change configurations if gNB-based sensing is activated. Also, for example, the WTRU may be configured with one or more Time Division Duplexing (TDD) configurations indicating frames or slots as downlink, uplink or special slots (e.g., mix of downlink or uplink symbols and/or blank slots or symbols, or the like). If the duration of gNB-sensing overlaps with the configured downlink, uplink or special slots, the WTRU may determine to convert the overlapped slots or symbols into blank slots or symbols, implying that the WTRU does not take any actions (e.g., no transmission of uplink channels or signals, no reception of downlink channels or signals, or the like).

In one example, for the time resources (e.g., slots, frames, symbols, or the like) that do not overlap the gNB-based sensing duration (e.g., time window during which gNB-based sensing is active), the WTRU may determine to keep the format of the time resources as configured (e.g., uplink symbols, downlink symbols, special symbols, or the like).

For example, cancellation behavior is provided. Also, for example, prior to the gNB-based sensing operation, the WTRU may be configured with TDD configurations, grants (e.g., configured grants, dynamic grants, or the like), or transmissions (e.g., periodic, semi-persistent, aperiodic UL-RS transmission, or the like). The WTRU may determine to transmit UL channels (e.g., PUCCH, PUSCH, or the like) or UL-RS. Also, for example, the WTRU may determine to transmit UL channels based on at least one: a cancellation of all scheduled or configured uplink channel or signal transmission if the uplink resources collide with gNB-based sensing resources (e.g., time and frequency resources, or the like); a cancellation of all scheduled or configured uplink channel or signal transmissions that collide with gNB-based sensing resources. Further, for example, scheduled or configured uplink channel or signal transmissions can be transmitted if they do not collide with the gNB-based sensing resources.

For example, a timer for gNB-sensing is provided. In one example, the WTRU may receive a message from the network to start a timer and the WTRU may determine to start a timer. Once the timer exceeds the configured threshold, the WTRU may determine that gNB sensing is deactivated.

For example, an expected starting time is provided. In one example, the WTRU may receive a message from the network, indicating that the gNB will perform sensing in the configured time (e.g., absolute time, relative time with respect to a reference time, or the like). The configured time may be expressed in a relative time in terms of the number of symbols, slots, frames, subframes, or the like.

Post-sensing WTRU action (e.g., after gNB-based sensing is deactivated) is provided. In one example, the WTRU may determine that the gNB-based sensing is terminated or deactivated (e.g., based on configurations of a time window). The WTRU may determine to update Tx and/or configurations to the default or fallback configuration. For example, the WTRU may determine to stop application of the power offset to the measurements (e.g., stop adding power offset to the power measurements) after the WTRU determines that the gNB-based sensing is terminated or deactivated. In another example, the WTRU may determine to stop application of the angle offset to the UL transmission direction or DL reception direction. In another example, the WTRU may determine to apply the default spatial relationship to the UL transmission direction or DL reception direction after the WTRU determines that the gNB-based sensing is terminated. The WTRU may send a message to the network, e.g., via LPP, RRC, UCI, MAC-CE, to report that the WTRU is using the default configurations for measurements, Tx direction and/or reception direction, or the like.

In one example, a network (e.g., base station) may transmit a message with a configuration for gNB-based sensing operation (e.g., explicit and/or implicit conditions, or the like) to the WTRUs via (e.g., cell-specific) System Information Block (SIB) and/or (e.g., dedicated) RRC message. The configuration may comprise a configuration-related L1 (Layer-1) transmission and/or one or more reception parameters to be used and/or applied by a WTRU while the gNB is performing gNB-based sensing (e.g., change in antenna tilt, duration of applied tilt, association between tilt and power offset, translation in spatial information, or the like).

For example, in an explicit manner, a WTRU may determine to apply the received configuration associated gNB-based sensing immediately upon receiving a message including configuration for gNB-based sensing. Upon receiving the activation of gNB-based sensing, the WTRU may determine to set and/or adjust and/or apply L1 parameters for the WTRU transmission and/or reception based on the received explicit configuration.

For example, in an implicit manner, a WTRU may determine to apply the received configuration associated gNB-based sensing based on the configured conditions. Also, for example, the WTRU may determine to use the received configuration when a measured RSRP value (e.g., SSB, CSI-RS, or the like) is below a threshold. Further, for example, the WTRU may determine to use the received configuration upon receiving at least one DL signal (e.g., associated configuration applied). Upon receiving the activation of gNB sensing, the WTRU may determine to set and/or adjust and/or apply L1 parameters for the WTRU transmission and/or reception based on the received implicit configuration.

In one solution, a network may request (e.g., event-based and/or periodically) to report when there are any changes and/or updates related to transmission (Tx) and/or reception (Rx) parameters. For example, the network may request reporting conditions in which at least one Tx and/or Rx parameter is used and/or changed and/or updated and/or at least one Tx and/or Rx parameter is changed and/or varied above a threshold of a delta value. The delta value may comprise an offset and/or measured value and/or spatial information, or the like.

In one example, a network may request to include a location of the WTRU (e.g., zone and/or absolute and/or related, or the like) and/or one or more timestamps when a WTRU reports the updated Tx and/or Rx parameters and/or sensing measurement results in the location. For example, the WTRU may report location information of the WTRU with Tx and/or Rx parameters and/or associated sensing measurement results. Also, for example, the reported Tx and/or Rx parameters may be associated with at least one location of one WTRU. Further, for example, the reported Tx and/or Rx parameters may be associated at least one sensing measurement result. In addition, for example, the reported Tx and/or Rx parameters may be associated at least one reported timestamp.

In one example, the WTRU may determine Tx and/or Rx parameters based on the location. For example, the WTRU may determine the Tx parameters (e.g., transmission filter, spatial domain filter, Tx direction, power offset, or the like) and/or Rx parameters (e.g., reception filter, reception direction, or the like) based on the location of the WTRU. The WTRU may report the location of the WTRU to the network. As a response, the WTRU may receive Tx parameters and/or Rx parameters the WTRU shall use.

In one example, a WTRU may report the Tx and/or Rx parameters with UL transmission via MAC-CE and/or UL RRC message and/or NAS message. For example, the WTRU may report the Tx and/or Rx parameters with sensing measurement results. Also, for example, the WTRU may report the Tx and/or Rx parameters with a sensing and/or positing layer message (e.g., LPP and/or SLPP, or the like).

In one example, a WTRU may report the updated Tx and/or Rx parameters as assistance information for gNB-based sensing. For example, a WTRU may report the updated (and/or desired) Tx and/or Rx parameters without a request from a network. Also, for example, a WTRU may report the desired Tx and/or Rx parameters for gNB-sensing based on the sensing measurement results. Further, for example, the WTRU may report the Tx and/or Rx parameters periodically and/or per event-based reporting. In addition, for example, the WTRU may indicate whether at least one Tx and/or Rx parameter is updated or not. Moreover, for example, a WTRU may report the updated Tx and/or Rx parameters once at least one parameter is changed and/or updated.

Downlink reference signals used for gNB-sensing may be monitored and acted on by a WTRU, such as making and reporting measurements such as CSI, leading to unnecessary computational and signaling overhead. The WTRU may also mistakenly interpret gNB-based sensing related downlink reference signals leading to undesired behaviors such as beam misalignment or redundant CSI measurements.

The WTRU may receive an indication from the network to use configurations in relation to the gNB-sensing. This mechanism allows for adjusting WTRU behaviors so as to avoid disrupting gNB-sensing processes, while also ensuring the WTRU's ability to perform other functions, such as communications, is not impacted.

In one solution, the WTRU receives an indication to apply a configuration for adjusting the WTRU transmission behaviors such as modifying or suspending of uplink transmissions on specific resource blocks, during specific time slots, or with respect to certain spatial directions. The indication of the configuration may include uplink muting, where the WTRU refrains from transmissions in the UL (e.g., PUSCH, PUCCH, SRS, or the like). In one example, the indication to the WTRU may be based on its location in certain a geographical area (e.g., sensing zone), or with respect to certain spatial directions (e.g., downlink reference signals), that may disrupt a gNB-sensing operation, or be negatively impacted by the gNB-sensing operation with respect to performing functions such as communications.

In one solution, the WTRU receives an indication to apply a configuration for adjusting the WTRU reception behaviors such as use of certain resources such as DL reference signals. This may include WTRU monitoring downlink signals (e.g., in specific time, frequency, spatial domains, or the like) based on the gNB-sensing schedule.

In one example, a WTRU may receive explicit indication for adjusting the WTRU transmission and/or reception behaviors from the network via a DCI message. This may include a bit or field in the DCI message to indicate activation of a gNB-sensing specific configuration, along with relevant parameters specifying the duration, affected channels and/or signals, time and/or frequency and/or spatial resources, or the like. In one example, the WTRU may receive an indication to activate and/or deactivate muting of an uplink transmission via a single bit in the DCI message. In another solution, the WTRU may receive through a DCI message an indication for using a certain set of resources such as downlink reference signals (e.g., subset of CSI-RS). In one solution, the WTRU may receive through the DCI message an index for one or a set of specific WTRU behaviors from a preconfigured set of WTRU behaviors, such as uplink muting, or adjusted reception.

In one solution, a WTRU may receive, e.g., via MAC signaling, dynamic adjustments to transmission and/or reception behaviors of the WTRU. For example, the WTRU may receive a MAC-CE to modify periodicity in which it monitors downlink reference signals that may be intended for gNB-based sensing, or specify a list of reference signal resources that the WTRU should not make measurements and/or to report on, e.g., CSI report, sensing report, or the like. In one example, the downlink reference signals used for gNB-sensing may overlap with resources that the WTRU is configured to monitor for downlink control signals (e.g., PDCCH, PDSCH, or the like). The WTRU may receive a MAC-CE to reduce or refine the search space for control channel monitoring during gNB-sensing operation. The WTRU may receive through MAC-CE a flag to suspend resource monitoring based on a gNB-sensing phase.

In one example, the WTRU may receive, from the network, an indication of a mode of the gNB (e.g., mode #1 and mode #2 correspond to communication and sensing mode, respectively). The WTRU may not be configured with implication of each mode. Based on the indicated mode, the WTRU may determine a transmission parameter of the WTRU (e.g., power offset, spatial relationship, or the like) or a transmission behavior of the WTRU (e.g., cancellation of uplink transmission, stop monitoring configured signals, or the like).

In one solution, a network may configure prioritization for sensing or communication operation (e.g., over other operations) among those performed in a configured search space (e.g., a time-frequency resource).

In one example, the network may configure to activate prioritization with at least one specific and/or common DL signal among a plurality of DL signals. For example, at least one specific signal may be associated with a DL-RSRP value. Upon receiving the associated DL signal (e.g., implicitly) that is measured above the RSRP value, the WTRU may activate the prioritized operation, e.g., sensing or communication. Also, for example, the network may activate the prioritization for sensing or communication operation via a DCI and/or MAC-CE and/or SIB and/or RRC message (e.g., cell specific), or the like. The indication of prioritization may comprise a 1-bit indication (e.g., 1: sensing, 0: communication, or the like). The WTRU may activate the prioritized operation upon receiving indication for prioritized operation. The indication of prioritization may be sent in a piggybacking manner with other DCI indications or RRC messages.

In one example, the configured prioritization may be associated with one or more dedicated time-frequency resources (e.g., a search space) and associated time durations and/or time windows and/or time gaps (e.g., msec, see, mins, or the like). For example, the operation for prioritization may be associated with a location (e.g., zone and/or absolute and/or relative position, or the like). The WTRU may be configured with prioritization and associated conditions and/or one or more resources from a network.

A WTRU may activated or deactivated to perform prioritization upon receiving an associated DL signal and/or receiving an indication from a network.

For example, regarding the prioritization for sensing or communication, in one solution, a WTRU may determine to search for a sensing signal during a search periodicity upon receiving the associated DL signal (e.g., configured with prioritization for sensing). Also, for example, one or more configured and/or specified DL signals may be indicated and/or associated with at least one or more DL signals (e.g., SSB index, DL reference, or the like). In one solution, a WTRU may determine to search for a sensing signal during the search periodicity upon receiving an indication of prioritization of a sensing operation. The indication may comprise a DCI and/or MAC-CE and/or SIB and/or RRC message, or the like.

For example, regarding the prioritization for sensing or communication, in one example, a WTRU may (e.g., firstly) measure sensing signals among the configured and/or specified DL signals among the DL signals (e.g., for the purpose of sensing) associated with a sensing operation. Also, for example, a WTRU may search and receive and/or monitor sensing signals (e.g., DL-RS) from one or more neighboring cells. Also, for example, the one or more configured and/or specified DL signals may be indicated and/or associated with at least one or more DL signals (e.g., SSB index, DL reference, CSI-RS, PTRS, PRS, TRS, or the like).

For example, regarding the prioritization for sensing or communication, in one example, a WTRU may keep monitoring and/or measuring sensing signals when, at least, the configured condition (e.g., time duration and/or location, or the like) is satisfied. Also, for example, a WTRU may report sensing measurement results while the condition is satisfied. Further, for example, the WTRU may report sensing measurement results during the time window and/or time gap for a sensing operation.

For example, regarding the prioritization for sensing or communication, in one example, upon receiving the indication (e.g., prioritization for communication), a WTRU may determine to search for a communication signal at a configured search periodicity. Also, for example, a WTRU may (e.g., firstly) measure detected sensing signals among the configured and/or specified DL signals among the DL signals (e.g., purpose of communication). Also, for example, a WTRU may search and receive communication signals (e.g., DL-RS) from one or more neighboring cells.

For example, regarding the reporting of deactivation of prioritization, in one solution, a WTRU may report sensing measurement results with an indication for the sensing operation. Also, for example, the WTRU may report to the indication (e.g., deactivation of prioritization) if at least one configured condition (e.g., location and/or time window) is not satisfied (e.g., out-of-location, timer is expired, out of time window, or the like).

For example, regarding the reporting of deactivation of prioritization, in one example, an indication for a sensing operation may comprise deactivation of monitoring of sensing signals and/or continuation of monitoring of sensing signals and/or activation of monitoring communication signals.

For example, one or more overriding configurations are provided. The WTRU configurations (e.g., UL transmissions and DL receptions) may be overridden by the gNB to enable gNB-sensing. The overriding of the configurations can be done through explicit signaling mechanisms such as RRC or MAC-CE.

In one solution, the WTRU may receive an indication for uplink muting (e.g., suspend transmission), to override a configuration related to all UL transmissions for a specified duration. Another solution is partial uplink muting whereby specific uplink channels or resources such as resource blocks are muted, e.g., suspending SRS transmission whilst continuing to send control feedback through PUCCH. In one example, the WTRU may receive a request to reduce or adjust its uplink transmission power for specific resource blocks or beams. The WTRU may receive (e.g., through RRC or MAC-CE) overriding configurations such as duration, channels, and resources for UL transmission muting. The WTRU may receive through RRC or MAC-CE activation of UL transmission adjustments, such as UL mute flag, duration field, and resources for muting.

For example, if the WTRU is configured with a muting pattern [1 1 0], the WTRU may determine that the WTRU mutes (e.g., cancels transmission) during the first two time units (e.g., slots, frames, subframes, symbols, or the like).

In one example, the WTRU may be configured with two or more muting patterns. In one example, the WTRU is configured with two or more muting patterns and determines a new muting pattern by performing an operation (e.g., AND, XOR, OR, or the like) on the configured muting patterns. The WTRU determines to apply the new muting pattern at a first set of one or more timings. The WTRU applies the configured muting patterns to the second set of one or more timings. The WTRU may be configured with the first and second sets of timings by the network.

For example, the WTRU is configured with two muting patterns [1 1 0] and [1 1 1 1 1 1 1 1 1 1 1 1 1 0] where each pattern consists of three and fourteen bits, respectively. The 3-bit pattern may correspond to the muting pattern at slot level. The 14-bit pattern may correspond to the muting pattern at symbol level. The WTRU may receive an indication to perform an OR operation between the two muting patterns. According to the configuration, the WTRU may determine that the WTRU mutes the first two slots. For the third slot, the WTRU may determine to mute the first 13 symbols.

In one solution, the WTRU may receive an indication for adjusting DL receptions, to override a configuration related to unnecessary monitoring or processing of downlink reference signals. The WTRU may receive an overriding configuration to discard specific downlink reference signals that may be used for gNB-sensing. In one solution, the WTRU may be configured to change the periodicity of monitoring certain downlink reference signals. In another solution, the WTRU configuration is such to avoid making measurements or reports with respect to downlink resources that are overlapping with downlink reference signals used for gNB-sensing, e.g., a WTRU PDCCH search space is reduced to exclude overlapping resources. The WTRU may receive, e.g., through RRC or MAC-CE, a list of downlink reference signal resource sets to ignore or adjust, in addition to an update of periodicity settings. The WTRU may receive through RRC or MAC-CE changes to monitoring parameters, such as a search space or monitoring periodicity.

The WTRU may determine to apply the transmission and/or reception behavior described herein if the WTRU determines that the gNB is performing gNB-based sensing (e.g., based on the indicated mode, configuration, indication from the network, or the like).

For example, network signaling for gNB-based sensing is provided. In one example, a network (e.g., base station) may receive information that a neighboring gNB is performing gNB-based sensing. For example, the neighboring base station (or a base station in proximity) and/or a core network may inform the gNB performing gNB-based sensing to the neighboring base station while detecting an obstacle (e.g., an unmanned aerial vehicle (UAV) and/or car and/or intruder, or the like). The information may be exchanged via inter-node signaling and/or one or more messages (e.g., Xn interface, NG interface, S1 interface, or the like) between nodes and/or a node and core network.

In one example, the base station may receive a request (e.g., performing the gNB-based sensing operation) via inter-node signaling and/or one or more messages (e.g., Xn interface, S1 interface, NG interface, or the like). For example, the base station may receive the request from a neighboring base station and/or a core network. Also, for example, the core network (e.g., LMF, a function like LMF, a sensing entity, a server, combinations of the same, or the like) may transmit an inter-node message (e.g., triggering gNB-based sensing, specific configuration and/or conditions with timer and/or time duration and/or time gap and/or a starting offset, or the like). Further, for example, the base station may trigger a gNB-based sensing operation upon receiving the request. The base station may report the sensing measurement results (e.g., gNB-based) to the core network.

For example, WTRU-assisted gNB-based sensing is provided. In one example, a network may configure to request and/or activate a gNB-based sensing operation to the network. For example, the request and/or activation of a configuration may comprise at least one condition and one or more UL resources for the request. Also, for example, a WTRU may be configured with a dedicated RACH preamble and/or an additional RACH occasions and/or a Scheduling Request (SR) and/or a configured grant and/or UCI.

A WTRU may request and/or activate gNB-based sensing (to the serving gNB) upon receiving an indication and/or DL signal and/or message.

In one solution, a WTRU may request (e.g., gNB-base sensing) to the serving gNB upon receiving at least one DL signal for sensing from a neighboring gNB. The DL signal may comprise at least one or more DL signals (e.g., SSB index, DL reference, CSI-RS, PTRS, PRS, TRS, or the like). For example, the WTRU may request to the serving gNB upon receiving at least one DL signal for sensing from a neighboring gNB in an implicit manner.

In one example, a WTRU may request (e.g., to the serving gNB) upon receiving an explicit indication from a neighboring gNB and/or cell. For example, the WTRU is configured with dual connectivity and/or performing neighboring cell selection and/or reselection. The explicit indication may comprise an indication and/or messages, e.g., DCI and/or MAC, CE and/or SIB, and/or RRC message (cell-specific and/or WTRU-specific, or the like) from a network (or one or more neighboring cells). Also, for example, the explicit indication may comprise activation of a gNB-based sensing signal. Further, for example, the indication may be configured to a specific WTRU via a dedicated message and/or specific cell via SIB.

In one example, a WTRU may request (e.g., to the serving gNB) the activation of gNB-based sensing via UL transmission upon receiving an explicit and/or implicit indication from a gNB in proximity (e.g., performing gNB-based sensing). The WTRU may send the request via UL transmission (e.g., SR and/or UCI and/or UL MAC-CE and/or UL grant, or the like). For example, the WTRU may send the indication via Small Data Transmission (SDT) (e.g., configured UL grant). Also, for example, the WTRU may send the request via an early indication method (e.g., MSG1 and/or MSG3, or the like). Each of the RACH preamble and/or occasion and/or indication for UL may associate with one or more preconfigured and/or configured DL signals.

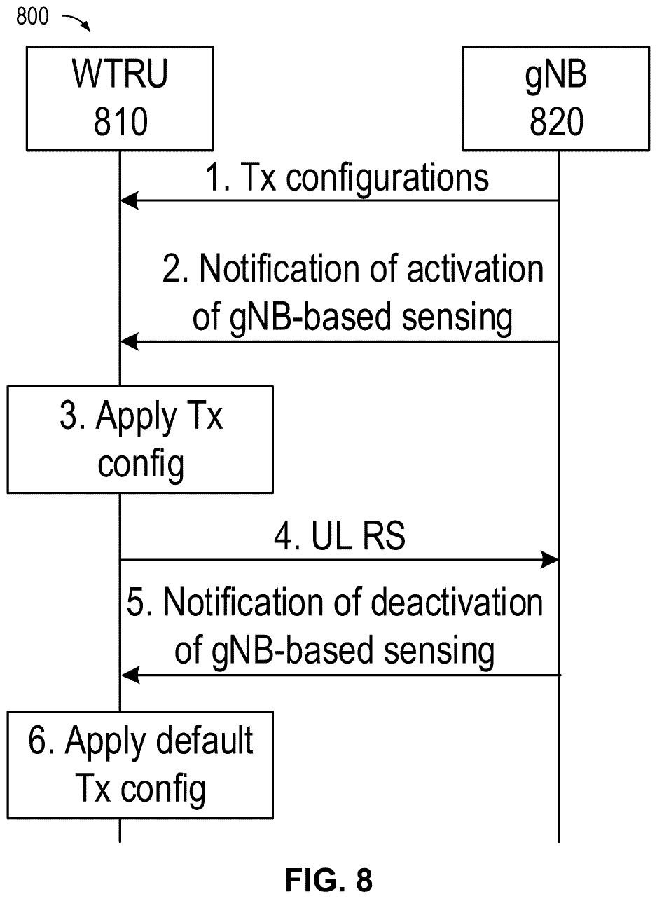

An example of signal exchange is illustrated in FIG. 8. As shown in FIG. 8, for example, a system 800 includes a WTRU 810 and a gNB 820. The system 800 may perform a method including one or more steps. For example, at step 1, the WTRU 810 may receive Tx configurations (e.g., power offset to measurements) to apply while gNB 820-based sensing is active. Also, for example, at step 2, the WTRU 810 may receive a notification from the gNB 820 that gNB-based sensing is active. Further, for example, at step 3, the WTRU 810 may determine to apply the Tx configuration. In addition, for example, at step 4, the WTRU 810 may transmit UL channels or RSs according to the Tx configuration. Moreover, for example, at step 5, the WTRU 810 may receive a notification from the gNB 820 that gNB-based sensing is deactivated. Furthermore, for example, at step 6, the WTRU 810 may determine to apply a Tx configuration (e.g., default or Tx configuration used prior to gNB-based sensing). In one example, the WTRU may receive a configuration and/or a request from the network to perform and report the measurements on the gNB sensing signal. In one example, the indication from the network may be an indication to activate a (e.g., preconfigured or configured) measurement window for the WTRU to perform one or more measurements. In one example, the WTRU may be configured with the gNB reference signal configurations (e.g., a sequence of the reference signal, time frequency resources, periodicity, or the like.), In such cases, the WTRU may be configured to perform at least one of the following measurements on the reference signal: power measurement, DL-RSRP, DL-RSRPP, angle-of-arrival (AoA), time-of-arrival (ToA), or the like. In another example, the WTRU may receive a request to report measurements made on the gNB sensing signal. In one solution, the WTRU may determine to report the measurement to the network based on at least one of the following conditions: at least one of the measurements (e.g., power measurement, DL-RSRP, DL-RSRPP, or the like) is above or below a preconfigured or configured threshold; the difference between at least one of the measurements is above or below a preconfigured or configured threshold; at least one statistic (e.g., variance) of a measurement is above or below a preconfigured or configured threshold, or the like. In another example, the WTRU may be configured to periodically report the downlink measurements. The WTRU may report at least one of the following to the network: at least one of the measurements (e.g., DL-RSRP, DL-RSRPP, AoA, ToA, or the like); at least one of the DL resource ID(s) associated with the measurement; WTRU location (e.g., in terms of 2D or 3D location, sector ID, cell ID, or the like.); timestamp of the measurement (e.g., in terms of symbol index, slot index, frame index, sub-frame index, absolute time, or the like); or the like. In one example, the WTRU may receive a message, from the network, to report measurements made on the sensing signals. The WTRU may receive configurations for a time window during which the WTRU is requested to make measurements. The WTRU may receive configurations of conditions (e.g., time limit, detection conditions, or the like) to start or stop measurements. The WTRU may receive configurations for measurements, which may include at least one of the following: specific sequence to make measurements; time frequency resources to make measurements; combinations of the same; or the like. In one example, the WTRU may receive a request to report the measurements to the network. The WTRU may receive configurations for reporting the measurements (e.g., periodic, semi-persistent, aperiodic, or the like). The WTRU may indicate details of measurements made by the WTRU such as time frequency resources (e.g., RB index, component carrier index, frequency layer index, bandwidth, center frequency, ARFCN, duration, start or end time, or the like); whether the measurements are processed (e.g., averaged); methods used to make measurements (e.g., envelop detection); or the like. In one example, the WTRU may receive a request to report measurements made at the configured or indicated resources. The WTRU may report the measurements at a periodicity configured by the network. The WTRU may make measurements on signals outside or inside of the active BWP. The WTRU may determine to terminate reporting once the power measurement is below the configured threshold and/or the WTRU receives an indication to stop reporting measurements. In one example, the WTRU may stop reporting if the WTRU reports a configured number of occasions to report. In another example, the WTRU may be configured with a time window during which the WTRU reposts measurements. The WTRU may stop reporting if the WTRU reaches the end of the time window for reporting.

According to the various embodiments and examples disclosed herein, a WTRU achieves at least one of the following improvements: determining optimal Tx and/or Rx parameters, reducing signaling overhead, avoiding unnecessary reconfiguration, avoiding interference to sensing and/or communication operations, combinations of the same, or the like.

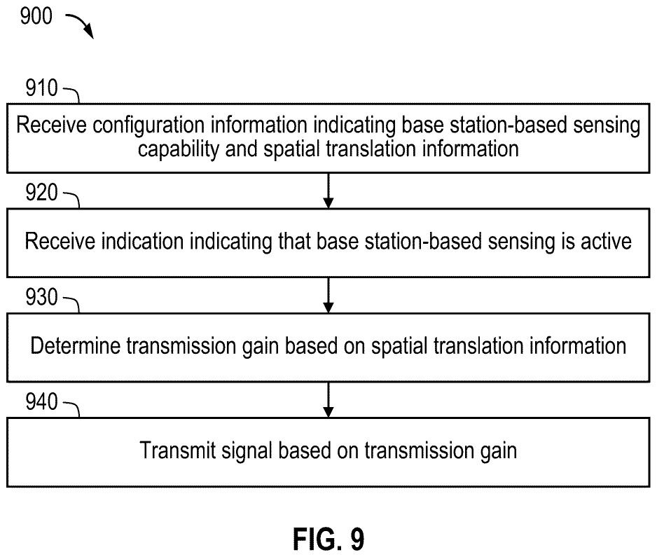

In certain representative embodiments, as shown in FIG. 9, a method 900 is performed by a wireless transmit/receive unit (WTRU) (e.g., WTRU 102, 320, 370, 430, 440, 530, 810, or the like) in communication with a wireless network (e.g., CN 106, 115, TRP 305, Tx TRP 355, Rx TRP 380, Tx gNB 410, Rx gNB 460, TRP 510, gNB 820, or the like). For example, the method 900 comprises at least one of: receiving 910, from the wireless network, configuration information indicating base station-based sensing capability and spatial translation information (e.g., step 1, FIG. 8); receiving 920, from the wireless network, an indication indicating that the base station-based sensing is active (e.g., step 2, FIG. 8); determining 930 a transmission gain based on the spatial translation information (e.g., at step 3, FIG. 8); and transmitting 940, to the wireless network, a signal based on the transmission gain (e.g., step 4, FIG. 8).

In some embodiments, the method 900 includes one or more additional features as follows. For example, the spatial translation information comprises at least one of a change in a tilt of an antenna, a duration of an applied tilt, an association between a tilt and a power offset, spatial direction information of an uplink reference signal (UL-RS) transmission, beam information of a UL-RS transmission, an angle of transmission of a UL-RS transmission, spatial direction information of a downlink reference signal (DL-RS) reception, a beam identifier used to receive a DL-RS, an angle of arrival of a DL-RS reception, or an index associated with a power offset and the spatial translation information (see, e.g., indications of configurations to use). Also, for example, the method 900 includes, based on a tilt applied at the base station, adding a power offset to a measured reference signal received power at the WTRU (see, e.g., power offset applied to measurements). Further, for example, the method 900 includes determining a subset of configured resources of the WTRU for the base station-based sensing (see, e.g., resource usage; e.g., FIG. 6). In addition, for example, the method 900 includes determining not to transmit or receive in certain time-frequency resources of time-frequency resources configured for base station-based sensing. Moreover, for example, the method 900 include, based on determining that a reference signal received power (RSRP) is above a configured threshold, increasing a measurement window for determination of the RSRP (see, e.g., measurement window). Furthermore, for example, the method 900 includes, based on determining that the RSRP is not above the configured threshold, suspending measurement performed by the WTRU. Additionally, for example, the method 900 includes performing one or more periodic measurements of a received communication transmission or a received sensing transmission. Still further, for example, the method 900 includes receiving a request from the wireless network to perform one or more periodic measurements. Even further, for example, the method 900 includes transmitting, to the wireless network, a report based on the one or more periodic measurements. Yet further, for example, the method 900 includes determining that the base station-based sensing is deactivated based on a received notification of deactivation of the base station-based sensing (e.g., step 5, FIG. 8). Further still, for example, the method 900 includes determining that the base station-based sensing is deactivated based on non-reception of a reference signal for sensing for a configured duration of time. For example, the method 900 includes determining a remaining amount of available time-frequency resources after base station-based sensing is deactivated. Also, for example, the method 900 includes utilizing the remaining amount of the available time-frequency resources for a communication operation of the WTRU.

In certain representative embodiments, a wireless transmit/receive unit (WTRU) (e.g., WTRU 102, 320, 370, 430, 440, 530, 810, or the like) is provided in communication with a wireless network (e.g., CN 106, 115, TRP 305, Tx TRP 355, Rx TRP 380, Tx gNB 410, Rx gNB 460, TRP 510, gNB 820, or the like). For example, the WTRU comprises a processor 118; and a transceiver 120 coupled to the processor. Also, for example, the WTRU is configured to perform one or more of the steps of method 900 described herein.

Throughout the specification the phrases “in response to” and “based on” shall be understood to have a broad meaning unless stated otherwise. For example, “in response to” can refer to a step that is in direct or indirect response to a prior step, and “based on” can refer to a step that is based at least in part on a prior step.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery or the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type of medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, § 6, 35 U.S.C. § 112 (f) or means-plus-function claim format, and any claim without the terms “means for” is not so intended.

What is claimed:

1. A method performed by a wireless transmit/receive unit (WTRU) in communication with a wireless network, the method comprising:
receiving, from the wireless network, configuration information indicating base station-based sensing capability and spatial translation information;
receiving, from the wireless network, an indication indicating that the base station-based sensing is active;
determining a transmission gain based on the spatial translation information; and
transmitting, to the wireless network, a signal based on the transmission gain.

2. The method of claim 1, wherein the spatial translation information comprises at least one of a change in a tilt of an antenna, a duration of an applied tilt, an association between a tilt and a power offset, spatial direction information of an uplink reference signal (UL-RS) transmission, beam information of a UL-RS transmission, an angle of transmission of a UL-RS transmission, spatial direction information of a downlink reference signal (DL-RS) reception, a beam identifier used to receive a DL-RS, an angle of arrival of a DL-RS reception, or an index associated with a power offset and the spatial translation information.

3. The method of claim 1, comprising:
based on a tilt applied at the base station, adding a power offset to a measured reference signal received power at the WTRU.

4. The method of claim 1, comprising:
determining a subset of configured resources of the WTRU for the base station-based sensing.

5. The method of claim 1, comprising:
determining not to transmit or receive in certain time-frequency resources of time-frequency resources configured for base station-based sensing.

6. The method of claim 1, comprising:
based on determining that a reference signal received power (RSRP) is above a configured threshold, increasing a measurement window for determination of the RSRP; and
based on determining that the RSRP is not above the configured threshold, suspending measurement performed by the WTRU.

7. The method of claim 1, comprising:
performing one or more periodic measurements of a received communication transmission or a received sensing transmission.

8. The method of claim 1, comprising:
receiving a request from the wireless network to perform one or more periodic measurements; and
transmitting, to the wireless network, a report based on the one or more periodic measurements.

9. The method of claim 1, comprising:
determining that the base station-based sensing is deactivated based on:
a received notification of deactivation of the base station-based sensing; or
non-reception of a reference signal for sensing for a configured duration of time.

10. The method of claim 1, comprising:
determining a remaining amount of available time-frequency resources after base station-based sensing is deactivated; and
utilizing the remaining amount of the available time-frequency resources for a communication operation of the WTRU.

11. A wireless transmit/receive unit (WTRU) in communication with a wireless network, the WTRU comprising:
a processor; and
a transceiver coupled to the processor, wherein the WTRU is configured to:
receive, from the wireless network, configuration information indicating base station-based sensing capability and spatial translation information;
receive, from the wireless network, an indication indicating that the base station-based sensing is active;
determine a transmission gain based on the spatial translation information; and
transmit, to the wireless network, a signal based on the transmission gain.

12. The WTRU of claim 11, wherein the spatial translation information comprises at least one of a change in a tilt of an antenna, a duration of an applied tilt, an association between a tilt and a power offset, spatial direction information of an uplink reference signal (UL-RS) transmission, beam information of a UL-RS transmission, an angle of transmission of a UL-RS transmission, spatial direction information of a downlink reference signal (DL-RS) reception, a beam identifier used to receive a DL-RS, an angle of arrival of a DL-RS reception, or an index associated with a power offset and the spatial translation information.

13. The WTRU of claim 11, comprising:
based on a tilt applied at the base station, adding a power offset to a measured reference signal received power at the WTRU.

14. The WTRU of claim 11, comprising:
determining a subset of configured resources of the WTRU for the base station-based sensing.

15. The WTRU of claim 11, comprising:
determining not to transmit or receive in certain time-frequency resources of time-frequency resources configured for base station-based sensing.

16. The WTRU of claim 11, comprising:
based on determining that a reference signal received power (RSRP) is above a configured threshold, increasing a measurement window for determination of the RSRP; and
based on determining that the RSRP is not above the configured threshold, suspending measurement performed by the WTRU.

17. The WTRU of claim 11, comprising:
performing one or more periodic measurements of a received communication transmission or a received sensing transmission.

18. The WTRU of claim 11, comprising:
receiving a request from the wireless network to perform one or more periodic measurements; and
transmitting, to the wireless network, a report based on the one or more periodic measurements.

19. The WTRU of claim 11, comprising:
determining that the base station-based sensing is deactivated based on:
a received notification of deactivation of the base station-based sensing; or
non-reception of a reference signal for sensing for a configured duration of time.

20. The WTRU of claim 11, comprising:
determining a remaining amount of available time-frequency resources after base station-based sensing is deactivated; and
utilizing the remaining amount of the available time-frequency resources for a communication operation of the WTRU.
